(19) United States
(12) Patent Application Publication
(10) Pub. No.: US 2026/0187265 A1
(43) Pub. Date: Jul. 2, 2026

(54) OMITTING SENSITIVE INFORMATION IN RECORDED CONVERSATION

(71) Applicant: MOTOROLA MOBILITY LLC, WILMINGTON, DE (US)

(72) Inventors: AMIT KUMAR AGRAWAL, BANGALORE (IN); NAKUL PATEL, NAGPUR (IN); KRISHNAN RAGHAVAN, BANGALORE (IN)

(21) Appl. No.: 19/003,546

(22) Filed: Dec. 27, 2024

(51) Int. Cl. G06F 21/62

(52) U.S. Cl. CPC G06F 21/6218

(57) ABSTRACT

A method provides techniques for omitting/removing sensitive information from recorded conversations. Audio/video (AV) data is captured on an electronic device for a meeting including multiple participants. A sensitive information context is detected within the captured AV data. A start point for the sensitive information context within the captured AV data is detected. An end point for the sensitive information context within the captured AV data is detected. A redacted meeting recording is created from the captured AV data, in which the redacted meeting recording omits information between the start point and the end point.

### BACKGROUND

### 1. Technical Field

The present disclosure generally relates to electronic devices utilized for multi-device audio/video conferencing, and more specifically to recording of meetings via electronic devices during audio/video conferencing.

### 2. Description of the Related Art

Online/virtual meetings play a crucial role in ensuring productivity and collaboration, especially when leveraging conference systems such as Microsoft Teams, Webex, Zoom, or similar platforms. Recording online meetings offers numerous benefits for productivity, collaboration, and later accessibility. For example, recordings allow participants to revisit discussions, ensuring that important details, decisions, or action items are not forgotten. Moreover, recording of meetings enables meeting participants who were unable to attend to catch up on the discussion by viewing the recording, promoting continuity and inclusivity. Thus, recording meetings can significantly enhance productivity, accountability, and accessibility, making the recording capability in audio/video conferencing a powerful tool for modern team collaboration.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2 illustrates an example teleconferencing environment, according to one or more embodiments;

FIG. 3 illustrates an example scenario in which an automated gesture recognition process is utilized for identifying sensitive information that is not to be recorded in a meeting transcript, according to one or more embodiments;

FIG. 4 illustrates an example user interface on an electronic device in which sensitive information mode is enabled and recording of sensitive content is paused/prevented, according to one or more embodiments;

FIG. 5 illustrates an example user interface on an electronic device in which sensitive information mode is enabled during playback of a previously recorded meeting, according to one or more embodiments;

FIG. 6 illustrates an exemplary user interface for configuration of a sensitive information management feature, according to one or more embodiments;

FIG. 7 depicts a flowchart of a computer-implemented method for omitting sensitive information in recorded conversation, according to one or more embodiments; and

FIG. 8 depicts a flowchart of a computer-implemented method for additional embodiments for omitting sensitive information in recorded conversation, according to one or more embodiments.

### DETAILED DESCRIPTION

According to aspects of the present disclosure, an electronic device, a method, and a computer program product provide techniques for omitting (not recording) sensitive information in recorded conversations and removing/suppressing sensitive information that was previously recorded. In some circumstances, participants in a conversation that is being recorded can forget, or be unaware, that the conversation in which they are participating is being recorded. Moreover, conversations can sometimes take an unexpected turn, resulting in a topic of discussion that is unplanned, and/or that may be sensitive in nature (i.e., not intended to be revealed to others and/or included in a meeting recording). When recordings of sensitive topics are made, and later shared, the resulting leak of the information can be damaging and/or embarrassing to the participants and/or others not a party to the conversation, such as their respective employers and/or organizations.

The disclosed embodiments address the aforementioned issues by managing recording of conversation based on dynamic contextual cues. The contextual cues can include phrases, such as “just between us . . . ” or “don't tell anyone this, but . . . ” which can be detected by the device processor from the audio stream and used by the processor to trigger activation of a sensitive information mode. When in sensitive information mode, recording of a live meeting may be paused during the discussion of the sensitive topic. In addition to spoken language, other cues such as visual cues, and/or body language can be used to trigger sensitive information mode. An example of such body language is when a user puts her finger over her lips to indicate information of a secret nature. Additionally, one or more embodiments can detect spoken and/or visual cues in a previously recorded meeting and create a new modified recording that excludes potentially sensitive information found in the original recording.

According to one aspect, audiovisual (AV) data from a multi-participant meeting is captured. A sensitive information context is identified within the captured AV data. In one or more embodiments, spoken dialog from the multi-participant meeting is monitored by a machine learning system that performs natural language processing (NLP) on the conversation from the meeting, to identify potentially sensitive information in the conversation, which can be indicative of a sensitive information context. When a sensitive information context is identified, corresponding sensitive information can be redacted and/or omitted from recordings and/or transcripts of the recordings. In one or more embodiments, the sensitive information can include, business-related sensitive topics such as strategic discussions regarding long-term business plans, mergers, acquisitions, and the like. The sensitive information can include financial information such as earnings reports and financial forecasts. The sensitive information can include legal matters such as pending lawsuits, disputes, intellectual property details, and the like. The sensitive information can include employee relations topics such as performance reviews, terminations, disciplinary actions, discussions regarding compensation, and the like. In addition to the aforementioned business-related topics, the sensitive information can include personal and/or socially sensitive topics such as gossip, inappropriate jokes or comments, political discussions, religious discussions, and the like. Other topics may be included in sensitive information in one or more embodiments.

One or more embodiments can provide an electronic device that includes: a communications subsystem enabling the electronic device to communicatively connect to at least one second electronic device; a memory having stored thereon a sensitive information management (SIM) module; and at least one processor coupled to the communications subsystem and the memory and which processes program code of the SIM module. The at least one processor is configured to cause the electronic device to: capture audio/video (AV) data for a meeting comprising a plurality of participants; detect a sensitive information context within the captured AV data; determine a start point for the sensitive information context within the captured AV data; determine an end point for the sensitive information context within the captured AV data; and create a redacted meeting recording from the captured AV data, wherein the redacted meeting recording omits information between the start point and the end point.

One or more embodiments can provide a method that includes capturing, on an electronic device, audio/video (AV) data for a meeting comprising a plurality of participants; detecting a sensitive information context within the captured AV data; determining a start point for the sensitive information context within the captured AV data; determining an end point for the sensitive information context within the captured AV data; and creating a redacted meeting recording from the captured AV data, wherein the redacted meeting recording omits information between the start point and the end point.

Further embodiments can provide a computer program product including: a non-transitory computer readable medium; and program code on the computer readable medium that when processed by a processor of an electronic device configures the processor to perform functions of the above-described method.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, and configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, “some embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

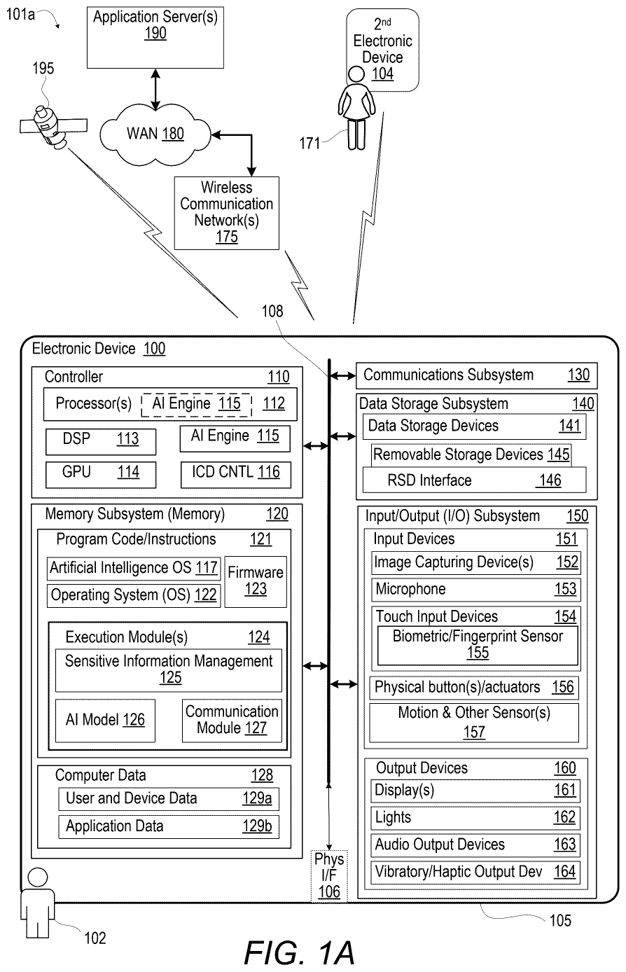

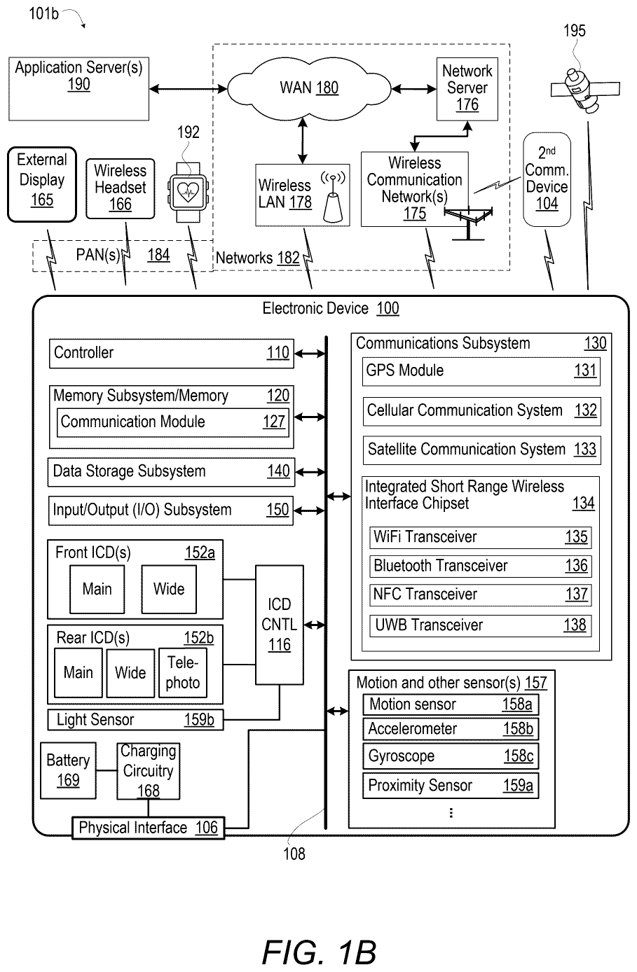

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments. Electronic device 100 can be configured to omit sensitive information in recorded conversations, such as with virtual meetings that utilize a conference system.

Examples of electronic device 100 can include, but are not limited to, mobile devices, a notebook computer, a mobile phone, a smart phone, a digital camera with enhanced processing capabilities, a smart watch, a tablet computer, and other types of electronic devices. For purposes of this disclosure, electronic device 100 is assumed to be a communication device that can be used to engage in a voice and/or video call with a second communication device. Electronic device 100 can therefore be interchangeably referred to herein as communication device 100.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113 graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122. Operating system 122 may include or be augmented by device AI operating system (OS) 117 that can include native support for AI-specific hardware such as Neural Processing Units (NPUs) or Tensor Processing Units (TPUs) to optimize performance for AI tasks such as machine learning inference and training.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, Sensitive Information Management (SIM) module 125, which provides the features and operating functionality of the disclosed embodiments when the corresponding program instructions of Sensitive Information Management (SIM) module 125 are processed by/within processor 112/controller 110.

Execution modules 124 further includes AI model(s) 126. In one or more embodiments, processor 112 can utilize AI models 126 to provide AI functionality of processor-integrated AI engine 115. In other embodiments, AI models 126 are directly utilized by AI engine 115. In one or more embodiments, AI model(s) 126 is integrated as a sub-module within SIM module 125 and is trained to support the AI features of SIM module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, SIM module 125 can include program instructions that cause or configure processor 112 to cause electronic device 100 to omit sensitive information in recorded conversations. Other features provided by SIM module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of SIM module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by a user to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which follows.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive a user's tactile/touch input. As a touch screen device, integrated display 161 allows a user to provide input to and/or to control electronic device 100 by touching features within a user interface presented on integrated display 161. Tactile, touch input device 154 can include a touch screen interface. The touch screen interface can include one or more virtual buttons or selectable affordances. In one or more embodiments, when a user 102 applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of device housing 105. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device 100 to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem 130 includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 171 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of SIM module 125 and/or access to other applications, online transactions, and resources. In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICD(s) can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image and/or iris scan recognition.

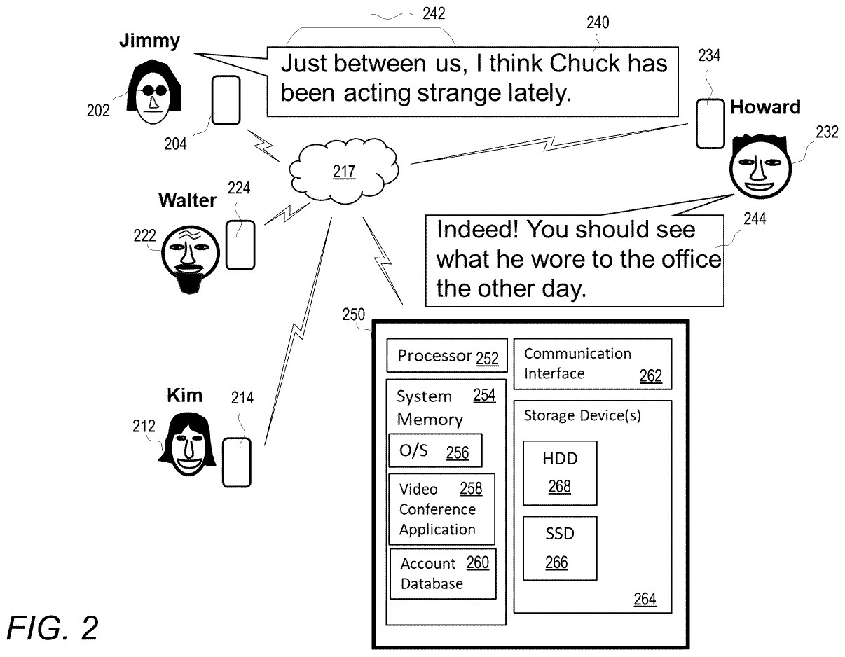

FIG. 2 illustrates an example teleconferencing environment, according to one or more embodiments. A first participant “Jimmy” 202 has an associated electronic device 204. A second participant “Kim” 212 has an associated electronic device 214. A third participant “Walter” 222 has an associated electronic device 224. A fourth participant “Howard” 232 has an associated electronic device 234. The electronic devices 204, 214, 224, and 234 may be similar to electronic device 100 shown in FIG. 1A. Electronic devices 204, 214, 224, and 234 are communicatively connected to video conferencing server 250 via network 217 during a video communication session. In one or more embodiments, two or more of the electronic device(s) further comprise a display, a camera, and a microphone, and the capturing of AV data comprises capturing at least a portion of the AV data via the camera and the microphone during a video call (meeting).

The video conferencing server 250 includes a processor 252. The processor 252 can include one or more cores. The processor 252 is coupled to system memory 254. System memory 254 can include a combination of volatile and non-volatile memories, such as DRAM, SRAM, Flash memory, and so on. The system memory 254 can include an operating system 256. In one or more embodiments, the operating system can include Windows, Linux, or other Unix variants. The system memory can include a video conference application 258. The video conferencing application 258 can include code, that when executed by the processor 252, performs various media processing functions such as transcoding, mixing, and encoding video and audio streams. The video conferencing application 258 can further include code, that when executed by the processor 252, performs various stream routing functions, such as directing AV streams between participants to minimize latency and ensure efficient use of bandwidth. Moreover, the code of video conferencing application 258 may provide support for implementing single sign-on (SSO), OAuth, or multi-factor authentication (MFA) for user verification. Additionally, the code of video conferencing application 258 may provide functionality for granting different levels of access to participants, such as host, co-host, presenter, or viewer. Furthermore, the code within video conferencing application 258 may provide support for recording and archiving of conferences. This can include storing video, audio, and shared content on the cloud with options for later access and editing, as well as automatically generating and storing meeting transcripts for later reference.

In one or more embodiments, for storage on a local device storage, for security purposes, only the redacted transcript and/or recordings is stored, as indicated at 284. The video conferencing application 258 can further include code, that when executed by the processor 252, performs and/or implements one or more features of disclosed embodiments. Other features may also be supported by the code of video conferencing application 258. System memory 254 can further include an account database 260. In one or more embodiments, the account database 260 can include a relation database, such as a structured query language (SQL) database. In one or more embodiments, for each user of the video conferencing application, user credentials, profile details, and role-based permissions are stored in the account database 260.

The video conferencing server 250 may further include a communication interface 262. The communication interface 262 may include one or more ethernet, gigabit ethernet (GbE), RJ-45 ports, SFP/SFP+/QSFP interfaces for fiber optic or high-speed copper connections, Fibre Channel (FC) interfaces, and/or other suitable communication interfaces. The video conferencing server 250 may include one or more storage devices 264. The storage devices may include solid-state drives (SSDs) 266, such as SATA SSDs, and/or NVMe SSDs for storing intermediate data, and may further include one or more hard disk drives (HDDs) 268, such as enterprise-grade HDDs which may be used for archiving recorded meetings and/or storing backups of user data and/or logs.

As an illustrative example of functionality of disclosed embodiments, as can be seen in FIG. 2, Jimmy 202 utters speech 240 which states “Just between us, I think Chuck has been acting strange lately.” The speech 240 includes phrase 242 “Just between us” which is a phrase that can indicate potentially sensitive information may follow phrase 242. In one or more embodiments, a list of such phrases that can indicate potentially sensitive information may be stored within, or made accessible to, video conferencing server 250. In one or more embodiments, speech 240 is analyzed using a natural language processing (NLP) process on a machine learning model that is trained to identify sensitive information. In one or more embodiments, detecting a sensitive information context further comprises identifying, via natural language processing, a word or phrase indicative of shared content being sensitive information. In one or more embodiments, the model training can include defining sensitive information categories, such as financial data, health information, business-sensitive data such as trade secrets and/or proprietary information, and the like. Additionally, heuristics may be applied with key phrases and/or idiomatic expressions that are detected using a regex process to identify cases where potentially sensitive information may follow. Additionally, facial recognition and/or gesture recognition may be incorporated into the machine learning models to identify non-audio cues (such as placing a finger over the lips) that potentially sensitive information is about to be revealed during the course of a conversation. In this way, disclosed embodiments can identify when potentially sensitive information is being spoken, and prevent recording during a live meeting and/or remove potentially sensitive information from previously recorded meetings.

Continuing with the example shown in FIG. 2, another participant, Howard 232 utters speech 244 in response to the speech 240 from Jimmy 202. In disclosed embodiments, when the speech following the speech that triggered the sensitive information context is determined to likely be a continuation of the subject of the triggering speech, the following speech is also redacted and/or not recorded. Thus, in one or more embodiments, the speech 244 may also be omitted from a recording of the conversation.

In one or more embodiments, the trigger to enter sensitive information mode may temporally follow the sensitive information itself. As an example, a first user may make a statement such as “I heard Kim is getting a promotion.” A second user may then respond: “Don't say anything about that yet, it is not public information at this time”. The phrase “Don't say anything about that yet” may trigger entry into sensitive information mode. Disclosed embodiments may then remove related audio data that preceded the trigger into sensitive information mode, thereby retroactively removing audio information once it is determined to be sensitive information based on the phrase that triggered entry into the sensitive information mode

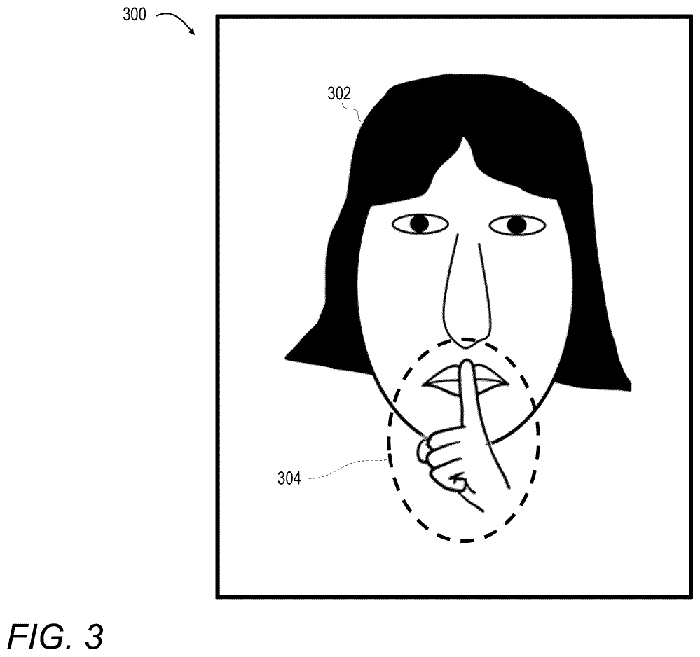

FIG. 3 illustrates an example scenario in which an automated gesture recognition process is utilized for identifying sensitive information that is not to be recorded in a meeting transcript, according to one or more embodiments. A video image 300 includes an image of a participant 302 that is performing a gesture 304. The gesture 304 includes putting one's finger over the lips, indicating potentially sensitive information. In embodiments, the image may be captured from a user-facing camera on an electronic device, such as electronic device 100 as shown in FIG. 1B. In one or more embodiments, the training of a machine learning model to detect gestures indicative of a sensitive information context can include identifying body parts involved in the gesture. In the example of FIG. 3, the body parts include hand and face of a user. The training can include capturing spatial relationships between the body parts, such as the hand near the lips, and the finger position relative to the lips, and/or other distinguishing criteria. Additional gestures recognized by disclosed embodiments can include hands cupped around the mouth, which may indicate whispering or sharing confidential information. The other gestures can include looking around before speaking, which may indicate checking for eavesdroppers, signaling that information about to be revealed may be sensitive. Other gestures may also be included in one or more embodiments. In one or more embodiments, detecting a sensitive information context further comprises identifying, via an automated gesture recognition process, a gesture that is pre-established to indicate that contemporaneously shared content is sensitive information. In one or more embodiments, the gesture that serves as a trigger to enter sensitive information mode may follow speech that predicated the gesture. As an example, a first user may make a statement such as “I heard Kim is getting a promotion.” A second user may then put his finger over his lips such as depicted in FIG. 3, serving as a gesture-based trigger to enter sensitive information mode. Disclosed embodiments may then remove audio data that preceded the gesture, thereby retroactively removing audio information once it is determined to be sensitive information based on the detected gesture. Embodiments can include: detecting a trigger into sensitive information mode; determining audio data related to the trigger that temporally precedes the trigger; and retroactively removing the audio data related to the trigger that temporally precedes the trigger from the redacted meeting recording.

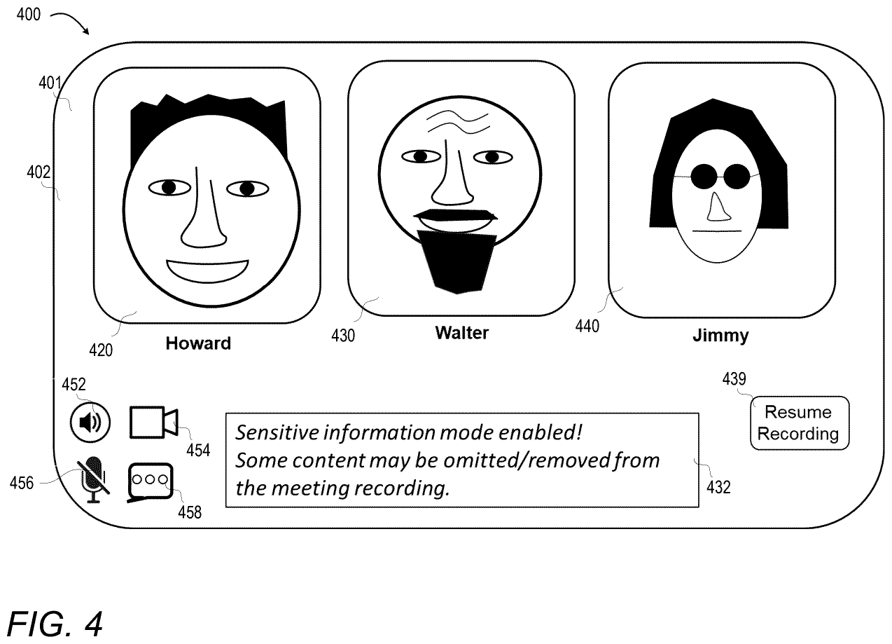

FIG. 4 illustrates an example user interface on an electronic device in which sensitive information mode is enabled and recording is omitted/removed, according to one or more embodiments. Device 400 may be similar to electronic device 100 depicted in FIG. 1A. Device 400 includes display 402. The user interface 401 can include functionality for implementing a virtual meeting. The user interface 401 can include a control 452 for muting/unmuting incoming audio, a control 456 for muting/unmuting outgoing audio, a control 454 for enabling/blocking outgoing video, and a control 458 for enabling a chat function. Additional controls are possible in one or more embodiments. The user interface shown in FIG. 4 shows three participants in respective video windows. Howard is shown in window 420. Walter is shown in window 430. Jimmy is shown in window 440. The user interface 401 shown in FIG. 4 can be rendered and presented based on the example conversation shown in FIG. 2.

Referring again to FIG. 4, an indication 432 is rendered and presented on the display 402 that indicates that sensitive information mode is enabled, and the recording on the live meeting is omitted/removed. In one or more embodiments, the indication 432 can be rendered and presented based on a message that is sent from a video conference server (e.g., video conferencing server 250 of FIG. 2), to one or more electronic devices associated with participants. In some embodiments, at least one processor is further configured to send a notification indicating that the sensitive information mode is enabled. The notification is sent to a second electronic device associated with each participant in response to determining that the sensitive information mode is enabled. One or more embodiments may further include an option to resume recording 439. In this way, once the sensitive information context discussion topic is complete, a participant can resume the recording. In one or more embodiments, when a participant invokes the option to resume recording 439, each electronic device that is being used as a communication terminal for the conference receives an indication that the recording has resumed. In one or more embodiments, the electronic device further comprises a display, a camera, and a microphone, and the capturing of AV data comprises capturing at least a portion of the AV data via the camera and the microphone during a video call.

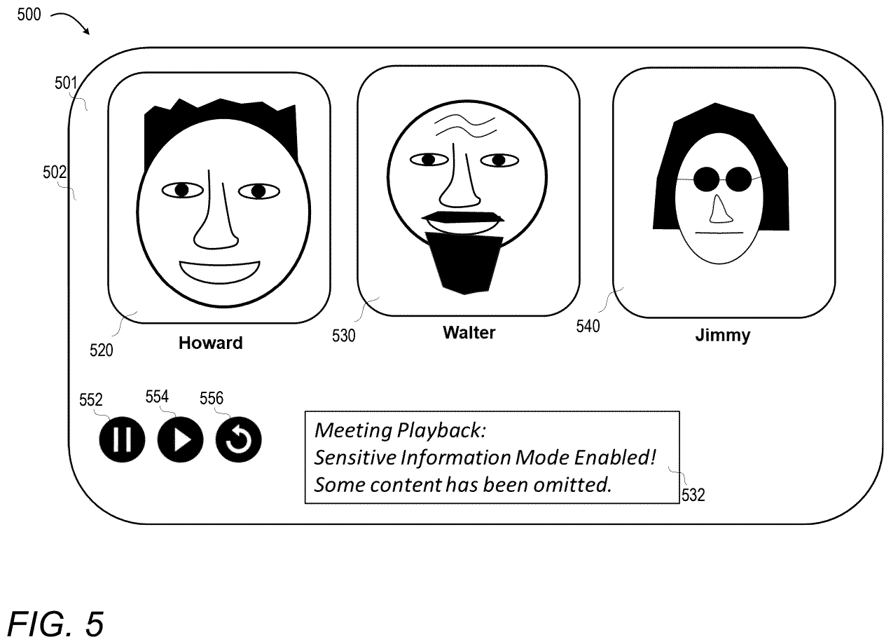

FIG. 5 illustrates an example user interface on an electronic device in which sensitive information mode is enabled during playback of a previously recorded meeting, according to one or more embodiments. Device 500 may be similar to electronic device 100 depicted in FIG. 1A. Device 500 includes display 502. The user interface 501 can include functionality for playback of a previously-recorded virtual meeting. In one or more embodiments, the captured AV data comprises a previously recorded meeting. The user interface 501 can include a control 552 for pausing the playback, a control 554 for resuming playback, and a control 556 for jumping back a pre-determined number of seconds (e.g., 10 seconds). Additional controls are possible in one or more embodiments. The additional controls can include a control for jumping forward, controls for fast forwarding and fast rewinding, and/or other types of controls. The user interface shown in FIG. 5 shows three participants in respective video windows. Howard is shown in window 520. Walter is shown in window 530. Jimmy is shown in window 540. The user interface 501 shown in FIG. 5 can be rendered and presented based on the example conversation shown in FIG. 2.

Referring again to FIG. 5, an indication 532 is rendered and presented on the display 502 that indicates that sensitive information mode is enabled, and some content from the meeting has been omitted. In one or more embodiments, the audio and/or video can be muted or redacted to conceal sensitive information, upon detecting a sensitive information context. One or more embodiments may create a punch in splice point at the start of a sensitive information context, and a punch out splice point at the end of a sensitive information context. In one or more embodiments, these splice points define a specific section of a video that gets removed to omit sensitive information from the recording.

In alternative embodiments, obfuscation may be applied, such as blurring and/or pixelation of video and/or image data. One or more embodiments can include applying an obfuscation effect to at least one participant among the plurality of participants during audible communication of sensitive information, to prevent lip-reading of spoken content related to the sensitive information. One or more embodiments may include an implementation in which indication 532 is not shown during playback of the meeting. In the mode of operation in which indication 532 is not shown during playback of the meeting, the redaction of meeting content is less obvious to viewers of the previously recorded meeting. In one or more embodiments, a user such as an administrator or meeting host has an option to show or conceal an indication such as indication 532.

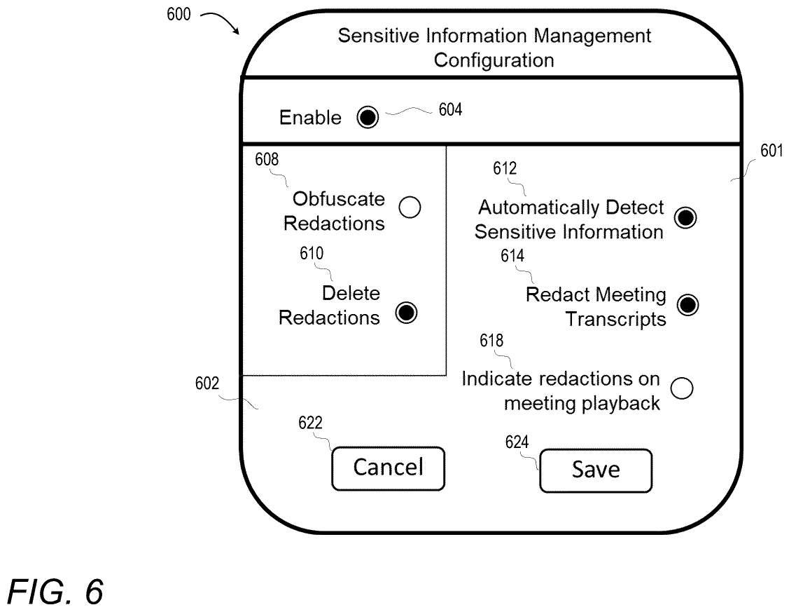

FIG. 6 illustrates an exemplary user interface for configuration of a sensitive information management feature, according to one or more embodiments. Device 600 may be similar to electronic device 100 depicted in FIG. 1A. Device 600 includes display 602. The user interface 601 can include an option to enable the sensitive information management feature 604, which is indicated as selected in FIG. 6. The user interface 601 that is rendered and presented on display 602 can include an option to obfuscate redactions 608, which is indicated as unselected in FIG. 6. The user interface 601 can include an option to delete redactions 610, which is indicated as selected. The user interface 601 can include an option to automatically detect sensitive information 612, which is indicated as selected. The option to automatically detect sensitive information may utilize speech-to-text processing, natural language processing, entity detection, sentiment analysis, and/or other techniques to identify potentially sensitive information. In one or more embodiments, when the option to automatically detect sensitive information 612 is not selected, the user of the device can be prompted to enter sensitive information mode when a sensitive information context is detected, instead of automatically entering sensitive information mode.

The user interface 601 can include an option to redact meeting transcripts 614, which is indicated as selected. One or more embodiments can include generating a transcript based on the redacted meeting recording, the transcript omitting sensitive information. The user interface 601 that is rendered and presented on display 602 can include an option to indicate redactions on meeting playback 618, which is indicated as unselected. When the option to indicate redactions on meeting playback 618 is selected, an indication such as indication 532 of FIG. 5 can appear on the display (with the recorded content) during meeting playback. When the option to indicate redactions on meeting playback 618 is unselected, an indication such as indication 532 of FIG. 5 does not appear during meeting playback, but the redacted content is not presented. A cancel option 622, when invoked, discards unsaved settings of the user interface of FIG. 6, and exits the user interface. A save option 624, when invoked, saves the settings of the user interface of FIG. 6 to memory, and exits the user interface.

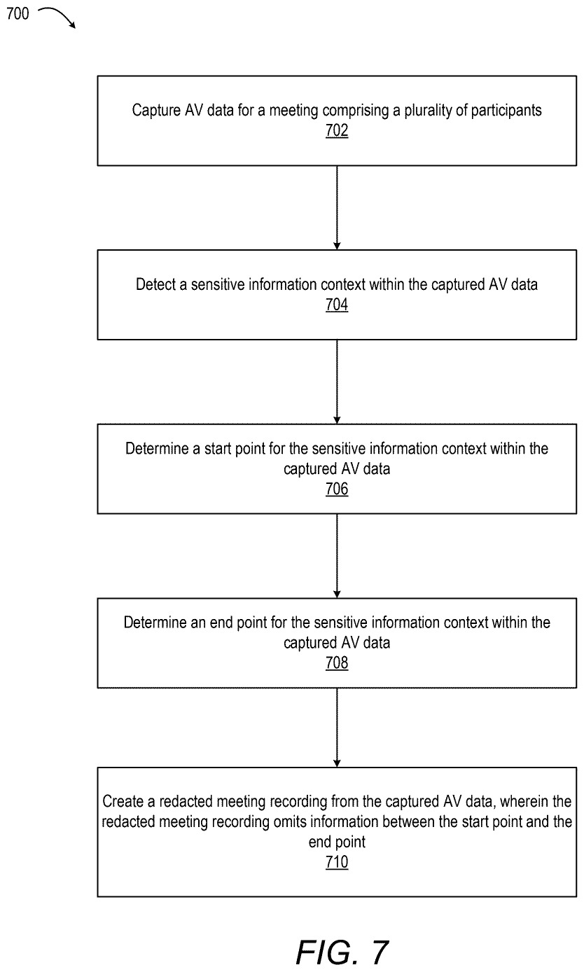

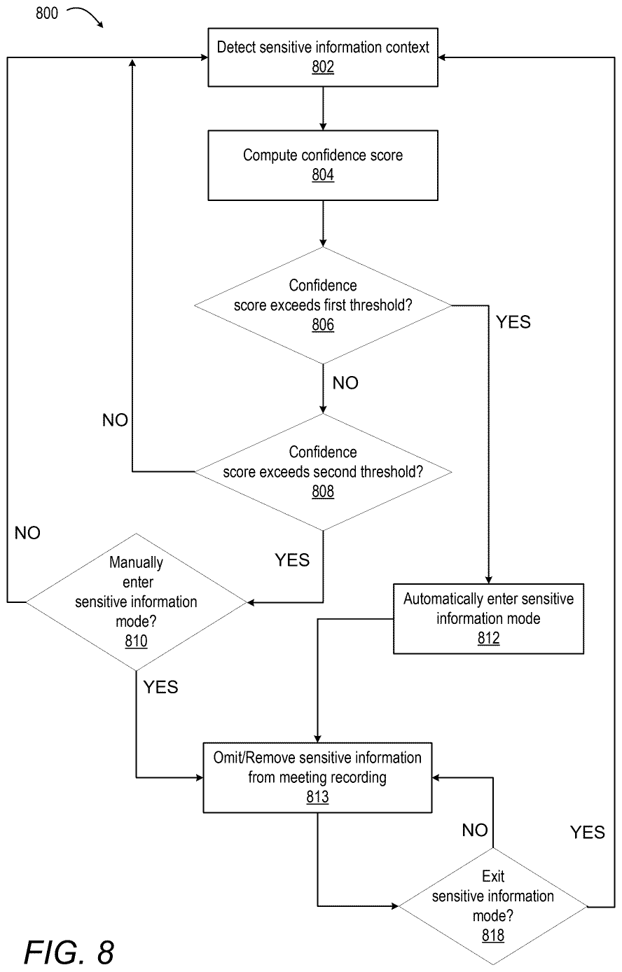

Referring now to the flowcharts presented by FIG. 7-FIG. 8, the descriptions of the methods in FIG. 7-FIG. 8 are provided with general reference to the specific components and features illustrated within the preceding FIGS. 1-6 . Specific components referenced in the methods of FIG. 7-FIG. 8 may be identical or similar to components of the same name used in describing preceding FIGS. 1-6 . In one or more embodiments, processor 112 (FIG. 1A) configures electronic device 100 (FIG. 1A) to provide the described functionality of the methods of FIG. 7-FIG. 8 by executing program code for one or more modules or applications provided within system memory 120 of electronic device 100, including Sensitive Information Management (SIM) module 125.

FIG. 7 depicts a flowchart of a computer-implemented method for omitting sensitive information in recorded conversation, according to one or more embodiments. The method 700 starts at block 702, where AV data for a meeting comprising a plurality of participants is captured. In one or more embodiments, the AV data is captured by a video conferencing server, such as video conferencing server 250 of FIG. 2. In some embodiments, the captured AV data is recorded on one or more storage devices 264 of the video conferencing server 250, such as hard disk drive 268 and/or solid-state device 266. In some embodiments, the captured AV data is recorded on one or more local devices (e.g., electronic devices 204, 214, 224, and/or 234 of FIG. 2), instead of, or in addition to, recording the AV data on the video conferencing server 250 of FIG. 2. The method 700 continues to block 704, where a sensitive information context within the captured AV data is detected. The captured AV data can include live audio data being recorded in real-time, or previously recorded AV data. Referring again to the example exchange shown in FIG. 2, a machine learning model can be trained to detect potential privacy concerns, contexts of confidentiality, and/or risk of harm. In one or more embodiments, a machine learning model can be trained via keyword analysis to detect phrases such as “Just between us” or “acting strange” which could be flagged as indicating potentially private or sensitive discussions. Moreover, embodiments may utilize named entity recognition (NER) for detecting personal names (e.g., Chuck) and associating them with subjective, potentially defamatory language, serving to help identify when third-party commentary is being made in a conversation that is being recorded or a conversation that has previously been recorded. In one or more embodiments, machine learning models can perform sentiment analysis to evaluate the sentiment and/or intent of statements to detect gossip, criticism, or judgment about absent individuals, and redact content accordingly.

The method 700 continues to block 706, where a start point for the sensitive information context within the captured AV data is determined, based on when the sensitive information context was detected. The method 700 continues to block 708, where an end point for the sensitive information context within the captured AV data is determined. In one or more embodiments, the end point for the sensitive information context can be determined automatically, by performing topic analysis, sentiment analysis, and/or other NLP techniques. In one or more embodiments, one or more of the participants may manually end the sensitive information context (e.g., by invoking the option to resume recording 439 as shown in FIG. 4). In one or more embodiments, the option to resume recording 439 may periodically blink or flash to remind a user that the conversation is currently not being recorded. In this way, the user is periodically reminded to check if the recording should be resumed, thereby preventing a loss of important information shared in subsequent conversations during the remainder of the meeting. In one or more embodiments, the option to resume recording 439 may periodically blink or flash for 5 seconds every three minutes. Other intervals for the flashing of the option to resume recording 439 are possible in disclosed embodiments.

The method 700 continues to block 710, where a redacted meeting recording is created from the captured AV data, where the redacted meeting recording omits audible information and redacts text-based transcripts of the audible information between the start point and the end point. In one or more embodiments, the creating of the redacted meeting recording can include identifying the start and end points, and associating the start points and end points with timestamps in originally recorded media. The content can then be split using standard editing techniques, into a starting segment which includes all content in the original media recording before the start point, an ending segment which includes all content in the original media recording after the end point, and a middle segment that includes all content in the original media recording between the start point and the end point. Embodiments can include deleting/omitting the middle segment from the redacted meeting recording and concatenating the ending segment to the starting segment. In some embodiments, the data set that includes the ending segment concatenated to the starting segment is re-encoded to enable smooth playback of the redacted meeting recording.

FIG. 8 depicts a flowchart of a computer-implemented method providing additional embodiments for omitting sensitive information in recorded conversation, according to one or more embodiments. The method 800 starts at block 802, where a sensitive information context is detected. In one or more embodiments, the sensitive information context can be detected using a variety of NLP techniques. The method 800 continues with computing a confidence score 804 which is indicative of the probability that the sensitive information context was correctly detected. In one or more embodiments, the machine learning model may utilize techniques including, but not limited to, a softmax function, thresholding, entropy-based confidence, and/or Bayesian inference. One or more embodiments can include: computing a confidence score corresponding to a detected sensitive information context; and in response to the confidence score equaling or exceeding a first threshold, automatically enabling a sensitive information mode.

The method 800 continues to block 806, where a check is made to determine if the confidence score exceeds a first threshold. If, at block 806, the confidence score exceeds the first threshold, the method 800 continues to block 812, where sensitive information mode is entered automatically. The method 800 then continues to block 813 where sensitive information is omitted/removed from a meeting recording. If at block 806, the confidence score does not exceed the first threshold, the method 800 continues to block 808, where a check is made to determine if the confidence score exceeds a second threshold, where the second threshold is less than the first threshold. If the confidence score does not exceed the second threshold, the method 800 returns to block 802.

If, at block 808, the confidence score exceeds the second threshold, the method 800 continues to block 810, where a prompt is rendered and presented on devices associated with a user to give the user an option to manually enter sensitive information mode. One or more embodiments can include, in response to the confidence score being less than the first threshold, and greater than a second threshold that is less than the first threshold, rendering and presenting a user selectable option to enable the sensitive information mode. If, at block 810, the user does not elect to enter sensitive information mode, the method 800 returns to block 802. If, at block 810, the user chooses to enter sensitive information mode, the method 800 continues to block 813 where sensitive information is omitted/removed from a meeting recording. In one or more embodiments, the omission of conversation can include pausing recording. The omission of sensitive information from a previously recorded meeting can include creating a new recording based on an original recording, where one or more portions of audio from the original recording are omitted from the new recording. The method 800 then continues to block 818 where a prompt is rendered and presented on devices associated with participants to give users an option to exit sensitive information mode. If, at block 818, the user does not elect to exit sensitive information mode, the method 800 returns to block 813 where sensitive information continues to be omitted. If, at block 818, the user chooses to exit sensitive information mode, the method 800 returns to block 802. In one or more embodiments, sensitive information mode may be exited automatically upon detecting (e.g., using NLP techniques) a topic change from a sensitive information topic to a non-sensitive information topic. In one or more embodiments, multiple devices may be used to accommodate multiple participants, where each device may provide similar functionality for the respective user to enter, exit, and/or monitor the sensitive information mode and/or operation. The flowcharts, sequences, and configurations presented herein are provided solely for illustrative purposes and are exemplary in nature. These embodiments are not intended to be limiting and may include variations with more, fewer, and/or alternative options, sequences, or features as would be apparent to those skilled in the art.

As can now be appreciated, disclosed embodiments provide techniques for omitting/redacting sensitive information in recorded conversations. Disclosed embodiments utilize AI-enabled NLP to enable real-time detection and removal of sensitive content, enhancing the capability to adapt to different contexts. Disclosed embodiments can further provide advanced features including detection of non-verbal cues (e.g., gestures signaling confidentiality) to further complement language-based detection. By integrating automatic omission/deletion of sensitive information, disclosed embodiments can significantly enhance privacy, reduce compliance burdens, and promote a secure and collaborative environment for all participants to recorded communication exchange.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined primarily by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a communications subsystem enabling the electronic device to communicatively connect to at least one second electronic device;
a memory having stored thereon a sensitive information management (SIM) module; and
at least one processor coupled to the communications subsystem and the memory and which processes program code of the SIM module, the at least one processor configured to cause the electronic device to:
capture audio/video (AV) data for a meeting comprising a plurality of participants;
detect a sensitive information context within the captured AV data;
determine a start point for the sensitive information context within the captured AV data;
determine an end point for the sensitive information context within the captured AV data; and
create a redacted meeting recording from the captured AV data, wherein the redacted meeting recording omits information between the start point and the end point.

2. The electronic device of claim 1, wherein to detect a sensitive information context, the at least one processor is further configured to identify, via natural language processing, a word or phrase indicative of shared content being sensitive information.

3. The electronic device of claim 1, wherein to detect a sensitive information context, the at least one processor is further configured to identify, via an automated gesture recognition process, a gesture that is pre-established to indicate that contemporaneously shared content is sensitive information.

4. The electronic device of claim 1, wherein the at least one processor is further configured to generate a transcript based on the redacted meeting recording, the transcript omitting sensitive information.

5. The electronic device of claim 1, wherein the at least one processor is further configured to apply an obfuscation effect to at least one participant among the plurality of participants during audible communication of sensitive information, to prevent lip-reading of spoken content related to the sensitive information.

6. The electronic device of claim 1, further comprising:
a display;
a camera; and
a microphone;
wherein the at least one processor is communicatively coupled to the display, the camera, and the microphone and is configured to cause the electronic device to capture at least a portion of the AV data via the camera and the microphone during a video call.

7. The electronic device of claim 6, wherein further, the at least one processor is configured to:
compute a confidence score corresponding to a detected sensitive information context; and
in response to the confidence score equaling or exceeding a first threshold, automatically enable a sensitive information mode.

8. The electronic device of claim 7, wherein further, the at least one processor is configured to:
in response to the confidence score being less than the first threshold, and greater than a second threshold that is less than the first threshold, render and present a user selectable option to enable the sensitive information mode.

9. The electronic device of claim 8, wherein the at least one processor is further configured to send a notification indicating that the sensitive information mode is enabled, to a second electronic device associated with each participant in response to determining that the sensitive information mode is enabled.

10. A method comprising:
capturing, on an electronic device, audio/video (AV) data for a meeting comprising a plurality of participants;
detecting a sensitive information context within the captured AV data;
determining a start point for the sensitive information context within the captured AV data;
determining an end point for the sensitive information context within the captured AV data;
and creating a redacted meeting recording from the captured AV data, wherein the redacted meeting recording omits information between the start point and the end point.

11. The method of claim 10, wherein detecting a sensitive information context further comprises identifying, via natural language processing, a word or phrase indicative of shared content being sensitive information.

12. The method of claim 10, wherein detecting a sensitive information context further comprises identifying, via an automated gesture recognition process, a gesture that is pre-established to indicate that contemporaneously shared content is sensitive information.

13. The method of claim 10, further comprising generating a transcript based on the redacted meeting recording, the transcript omitting sensitive information.

14. The method of claim 10, further comprising applying an obfuscation effect to at least one participant among the plurality of participants during audible communication of sensitive information, to prevent lip-reading of spoken content related to the sensitive information.

15. The method of claim 10, wherein the electronic device further comprises a display, a camera, and a microphone, and wherein the capturing of AV data comprises capturing at least a portion of the AV data via the camera and the microphone during a video call.

16. The method of claim 15, further comprising:
computing a confidence score corresponding to a detected sensitive information context; and
in response to the confidence score equaling or exceeding a first threshold, automatically enabling a sensitive information mode.

17. The method of claim 16, further comprising, in response to the confidence score being less than the first threshold, and greater than a second threshold that is less than the first threshold, rendering and presenting a user selectable option to enable the sensitive information mode.

18. The method of claim 10, further comprising:
detecting a trigger into sensitive information mode;
determining audio data related to the trigger that temporally precedes the trigger; and
retroactively removing the audio data related to the trigger that temporally precedes the trigger from the redacted meeting recording.

19. A computer program product comprising a non-transitory computer readable medium having program instructions that when executed by a processor of an electronic device comprising a display, configure the electronic device to perform functions comprising:
capturing audio/video (AV) data for a meeting comprising a plurality of participants;
detecting a sensitive information context within the captured AV data;
determining a start point for the sensitive information context within the captured AV data;
determining an end point for the sensitive information context within the captured AV data; and
creating a redacted meeting recording from the captured AV data, wherein the redacted meeting recording omits information between the start point and the end point.

20. The computer program product of claim 19, further comprising program instructions for identifying, via natural language processing, a word or phrase indicative of shared content being sensitive information.
